(19) United States
(12) Patent Application Publication
(10) Pub. No.: US 2007/0029950 A1
(43) Pub. Date: Feb. 8, 2007

(54) Liquid crystal display with flat fluorescent lamp and controlling method thereof

(75) Inventors: Hyeon-Yong Jang, Osan-si (KR); Jong-Cheol Lee, Suwon-si (KR)

Correspondence Address: F. CHAU & ASSOCIATES, LLC, 130 WOODBURY ROAD, WOODBURY, NY, 11797, US

(73) Assignee: Samsung Electronics Co., LTD

(21) Appl. No.: 11/354,463

(22) Filed: Feb. 15, 2006

(30) Foreign Application Priority Data
Aug. 3, 2005 (KR) 2005-71140

(51) Int. Cl. H05B 39/04

(52) U.S. Cl. 315/309

(57) ABSTRACT

An LCD shuts down an inverter when a supply time of a high current from the inverter to a lamp exceeds an allowable time, and also controls the allowable time according to an ambient temperature, thereby minimizing damage to a lamp due to overheating in a high-brightness driving operation.

### CROSS-REFERENCE TO RELATED APPLICATIONS

This U.S. non-provisional patent application claims priority under 35 U.S.C. §119 to Korean Patent Application 2005-71140 filed on Aug. 3, 2005, the entire contents of which are hereby incorporated by reference.

### BACKGROUND OF THE INVENTION

1. Field of the Invention

The present invention relates to a flat panel display, and more particularly, to a system and method for controlling a lamp of a liquid crystal display.

2. Description of Related Art

Display devices are an important part of the user interfaces of electronic devices. Flat panel displays are widely used as part of the user interfaces for light and slim electronic devices with low power consumption. The flat panel displays may be classified into organic light emitting diodes (OLEDs), liquid crystal displays (LCDs), field emission displays (FEDs), vacuum fluorescent displays (VFDs), and plasma display panels (PDPs). Larger flat panel displays are used as computer displays or TV displays. Smaller flat panel displays are used in portable electronic devices where small size and light weight are important for reducing space and power needs.

Rod-shaped cold cathode fluorescent lamps (CCFL) and dot-shaped light emitting diodes (LED) are widely used as light sources of the LCDs. The CCFLs characteristically have high brightness and long lifetime, and generate less heat than an incandescent lamp. Both the CCFLs and LEDs have poor brightness uniformity. A surface light source has been proposed as a solution to the poor brightness uniformity.

In the case of an LCD using a surface light source as a backlight, it can take a long time to stabilize the LCD to a normal brightness in an initial power-on mode. To reduce a brightness stabilization time, a high current greater than a normal current is supplied to the backlight in the power-on mode, so that high brightness is obtained and a lamp heating time is reduced. For example, an LCD TV supplies high current to the backlight during its operation, including the power-on mode, as so to display an image having high-brightness.

If the high current is continuously supplied to the backlight, a temperature of the lamp can rise excessively. Pinholes may be formed in the lamp due to overheating. The pinholes prevent proper operation of the lamp.

Therefore, a need exists for a system and method for limiting the supply time of the high current to the lamp.

### SUMMARY OF THE INVENTION

According to an exemplary embodiment of the present invention, an LCD includes a lamp, an inverter for driving the lamp and supplying a first current to the lamp, and an inverter controller for shutting down the inverter when a supply time of the first current from the inverter to the lamp exceeds an allowable time, and for changing the allowable time according to an ambient temperature while the high current is supplied from the inverter to the lamp.

The LCD further includes a microcontroller for outputting a first-brightness command signal in a power-on mode. The inverter supplies the first current to the lamp in response to the first-brightness command. The microcontroller outputs the first-brightness command signal in response to an external image data. The microcontroller generates a first reset signal for resetting the inverter controller in the power-on mode.

The inverter controller reduces the allowable time in proportion to a rate of increase of the ambient temperature while the first current is supplied from the inverter to the lamp, and activates a shutdown signal when the allowable time elapses. The inverter does not drive the lamp when the shutdown signal is activated by the inverter controller.

According to an exemplary embodiment of the present invention, the inverter controller includes a comparator for activating a first signal when the first current is supplied from the inverter to the lamp, a temperature detector for outputting a second signal of a level corresponding to the ambient temperature, and a control circuit for outputting a third signal to shut down the inverter when a time proportional to a rate of change of the second signal elapses while the first signal is activated. The temperature detector comprises a thermistor. The LCD further includes a reset circuit for generating a second reset signal to reset the control circuit.

According to an exemplary embodiment of the present invention, the inverter controller includes a comparator for activating a first signal when the first current is supplied from the inverter to the lamp, a temperature detector for outputting a second signal of a level corresponding to the ambient temperature, an oscillator for outputting a clock signal of a frequency corresponding to a level of the second signal while the first signal is in an active state, a counter for outputting a count value in synchronization with the clock signal, and a controller for outputting a third signal to shut down the inverter when the count value reaches an upper limit value. The temperature detector comprises a thermistor.

The temperature detector detects a temperature of a region adjacent to the lamp on a circuit board of the inverter controller.

The LCD further includes a power supply for supplying a power supply voltage to the inverter. The lamp includes a flat fluorescent lamp.

According to an exemplary embodiment of the present invention, a controlling method of an LCD includes determining whether a first current is supplied from an inverter to a lamp. An ambient temperature is detected when the first current is supplied from the inverter to the lamp. The method includes determining whether a detected ambient temperature is higher than a predetermined temperature, determining whether a supply time of the first current from the inverter to the lamp exceeds an allowable time, and shutting down the inverter when the supply time of the first current exceeds the allowable time, and the inverter is shut down when the ambient temperature exceeds the predetermined temperature within the allowable time.

The controlling method further includes determining whether the first current is supplied when the supply time of the first current does not exceeds the allowable time.

According to an exemplary embodiment of the present invention, a controlling method of an LCD includes determining whether a first current is supplied from an inverter to a lamp. An ambient temperature is detected when the first current is supplied from the inverter to the lamp. The method includes generating a clock signal of a frequency corresponding to the detected ambient temperature, and increasing a count value in synchronization with the clock signal. The method includes determining whether the count value reaches a predetermined count value, and shutting down the inverter when the count value reaches the predetermined value.

The controlling method further includes determining whether the high current is supplied when the count value does not reach the predetermined count value.

The operation of shutting down the inverter includes activating a shutdown signal.

The inverter controller shuts down the inverter when the supply time of the first current from the inverter to the lamp exceeds a preset time, and reduces the supply time of the first current according to a rate of increase of the ambient temperature.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a block diagram of display system;

FIG. 2 is a block diagram of an inverter controller according to a preferred embodiment of the present invention;

FIG. 3 is a flowchart illustrating an operation of the inverter controller of FIG. 2;

FIG. 4 is a block diagram of an inverter controller according to an embodiment of the present invention;

FIG. 5 is a flowchart illustrating an operation of the inverter controller of FIG. 4;

FIG. 6 is a graph illustrating a lamp current and an ambient temperature over time when the LCD is driven in a high brightness mode;

FIG. 7 is a graph illustrating a lamp current and an ambient temperature over time, showing an example in which an inverter supplies a lamp with a higher current than a normal current even after a critical time due to an erroneous operation of a microcontroller illustrated in FIG. 1;

FIG. 8 is a graph exemplarily illustrating an abnormal increase of an ambient temperature;

FIG. 9 is a timing diagram of signals used in the inverter controller of FIG. 4 according to a change of an ambient temperature; and

FIG. 10 is a circuit diagram of an inverter controller according to an embodiment of the present invention.

### DETAILED DESCRIPTION OF PREFERRED EMBODIMENTS

Reference will now be made in detail to preferred embodiments of the present invention, examples of which are illustrated in the accompanying drawings. However, the present invention is not limited to embodiments illustrated herein after, and embodiments herein are rather introduced to provide easy and complete understanding of the scope and spirit of the present invention.

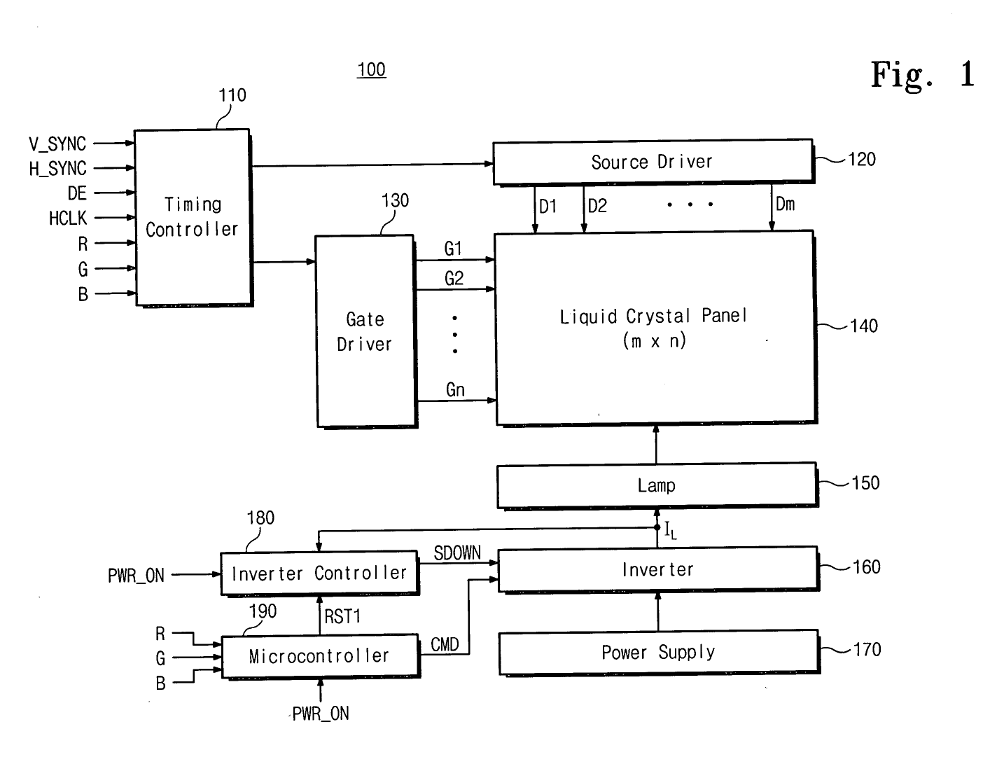

FIG. 1 is a block diagram of an LCD flat panel display. FIG. 1 depicts an example of and LCD, however the present invention can be applied to any LCD using a flat fluorescent lamp.

Referring to FIG. 1, the LCD 100 includes a timing controller 110, a source driver 120, a gate driver 130, a liquid crystal panel 140, a lamp 150, an inverter 160, a power supply 170, an inverter controller 180, and a microcontroller 190.

The liquid crystal panel 140 includes a plurality of gate lines G1 to Gn, a plurality of data lines D1 to Dm, and a plurality of pixels arranged at intersections of the gate lines and the data lines in a matrix form. Each of the pixels includes a thin film transistor (TFT) (not shown), a liquid crystal capacitor (not shown), and a storage capacitor (not shown). The TFT has a gate electrode connected to the gate line, a source electrode connected to the data line, and a drain electrode connected to the liquid crystal capacitor and the storage capacitor. The gate lines are sequentially selected by the gate driver 130. When a gate-on-voltage is applied to selected gate lines in a pulse shape, the TFTs connected to the gate lines are turned on. A voltage containing pixel information is applied to each of the data lines by the source driver 120. The voltage containing pixel information is applied to the liquid crystal capacitor and the storage capacitor through the TFT of the corresponding pixel. The liquid crystal capacitors and the storage capacitors are driven and an image display operation is achieved.

The timing controller 110 receives a vertical sync signal V_SYNC, a horizontal sync signal H_SYNC, a data enable signal DE, a clock signal HCLK, and image data R, G and B. The timing controller 110 outputs data signals having data formats converted according to specifications of the liquid crystal panel 140, and control signals such as a start horizontal signal (STH) and a load signal (TP) to the source driver 120. The timing controller 110 outputs control signals, such as a start vertical signal (STV1), a gate clock signal (CPV) and an output enable signal (OE), to the gate driver 130 in response to the horizontal sync signal H_SYNC, the vertical sync signal V_SYNC, and the data enable signal DE.

The source driver 120 generates signals for driving the source lines D1 to Dm of the liquid crystal panel 140 in response to the data signals and control signals supplied from the timing controller 110.

The gate driver 130 sequentially scans the gate lines G1 to Gn of the liquid crystal panel 140 according to the control signals supplied from the timing controller 110. Through scanning the pixels are made recordable by sequentially applying the gate-on-voltage to the gate lines.

The power supply 170 generates voltages needed for the operation of the LCD 100. The inverter 160 receives a voltage from the power supply 170 and outputs a normal current or a high current, which is suitable for driving the lamp 150. The high current represents a current higher than a normal current and is set to a level suitable for high-brightness driving of the lamp 150.

The microcontroller 190 receives the image data R, G and B and power-on signal PWR_ON from the exterior, and generates a high-brightness command signal CMD to the inverter 160. The microcontroller 190 generates a reset signal RST1 to the inverter controller 180. The microcontroller 190 generates the high-brightness command signal CMD when the inputted image data R, G and B are data needed for high-brightness display, or when the power-on signal PWR_ON is activated. The microcontroller 190 generates the reset signal RST1, which is supplied to the inverter controller 180 when the power-on signal PWR_ON is activated, or when the high-brightness command signal CMD is outputted. The inverter 160 generates the high current to the lamp 150 in response to the high-brightness command signal CMD.

The inverter controller 180 detects a current I_{L} that is supplied from the inverter 160 to the lamp 150. When a supply time of the high current from the inverter 160 to the lamp 150 exceeds an allowable time, the inverter controller 180 activates a control signal SDOWN for shutting down the inverter 160. When an ambient temperature is higher than a predetermined temperature within the allowable time, the inverter controller 180 activates the control signal SDOWN.

According to an embodiment of the present invention, the microcontroller 190 is designed to activate the high-brightness command signal CMD for high-brightness driving of the lamp 150 and to deactivate the high-brightness command signal CMD when a predetermined time elapses from the activation time of the command signal CMD. The high-brightness command signal CMD for supplying the high current from the inverter 160 to the lamp 150 is a short pulse signal, and the microcontroller 190 can supply a separate control signal to the inverter 160 so as to interrupt the high current from the inverter 160 to the lamp 150. The lamp 150 may be damaged by overheating, for example, if the control signal for interrupting the high current is not supplied to the inverter 160 due to an erroneous operation of a timer or damaged circuits within the microcontroller 190.

The inverter controller 180 activates the control signal SDOWN for shutting down the inverter 160, when an ambient temperature is higher than the predetermined temperature while the high current is supplied from the inverter 160 to the lamp 150, and/or when the supply time of the high current from the inverter 160 to the lamp 150 exceeds the allowable time. Accordingly, the inverter controller 180 can reduce a likelihood that the lamp 150 is damaged by overheating, even in a case where the microcontroller 190 does not operate normally.

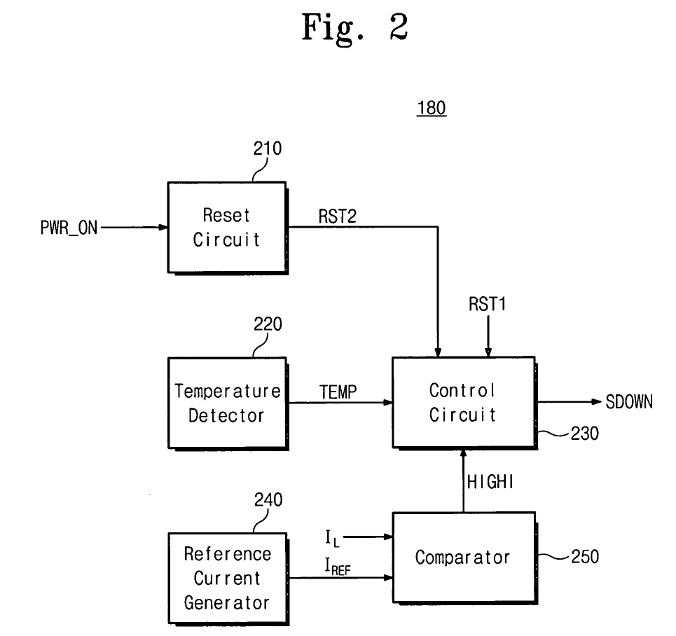

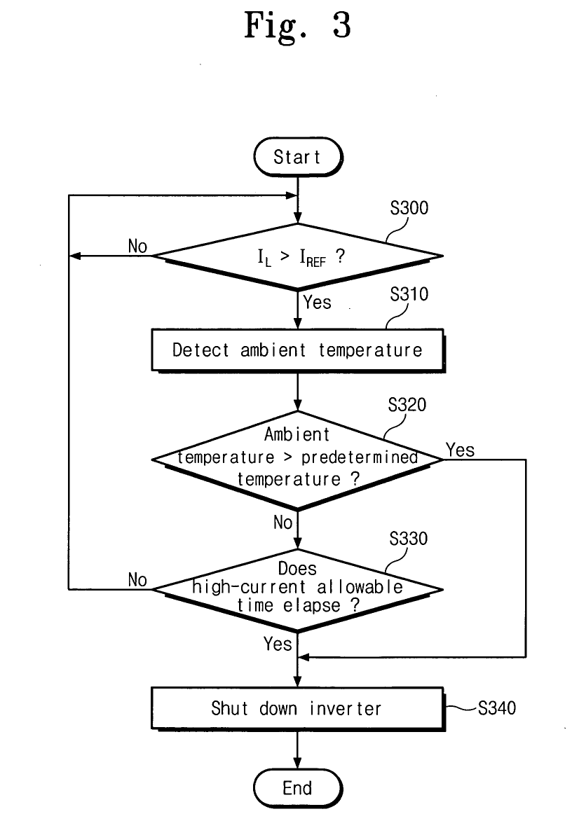

FIG. 2 is a block diagram of the inverter controller 180 according to an embodiment of the present invention, and FIG. 3 is a flowchart illustrating an operation of the inverter controller of FIG. 2.

Referring to FIG. 2, the inverter controller 180 includes a reset circuit 210, a temperature detector 220, a control circuit 230, a reference current generator 240, and a comparator 250.

The reset circuit 210 outputs a reset signal RST2 for resetting the control circuit 230 when the LCD 100 is reset or powered on.

The reference current generator 240 generates a reference current I_{REF} corresponding to the high current supplied from the inverter 160 to the lamp 150 so as to drive the liquid crystal panel 140 in the high brightness state.

The comparator 250 compares the reference current I_{REF} with the current I_{L} supplied from the inverter 160 to the lamp 150. When it is determined that the high current is supplied from the inverter 160 to the lamp 150, the comparator 250 activates a high-current detection signal HIGHI (operation S300).

The temperature detector 220 detects an ambient temperature, and outputs a temperature detection signal TEMP of a level corresponding to a detected temperature (operation S310). Preferably, the temperature detector 220 is located adjacent to the lamp 150 so as to detect a temperature increase of the lamp 150.

The control circuit 230 is reset in response to the reset signal RST1 from the microcontroller 190 of FIG. 1 and the reset signal RST2 from the reset circuit 210 of the inverter controller 180. The control circuit 230 activates the control signal SDOWN for shutting down the inverter 160 when the level of the temperature detection signal TEMP corresponds to a temperature higher than the predetermined temperature while the high-current detection signal HIGHI is in an activated state (operation S340). When a high-current allowable time elapses after the high-current detection signal HIGHI changes from an inactive state to an active state (operation S330), the control circuit 230 activates the control signal SDOWN for shutting down the inverter 160 (operation S340).

The control circuit 230 activates the control signal SDOWN when the high-current allowable time elapses after the high-current detection signal HIGHI changes from the inactive state to the active state. In addition, even before the allowable time elapses, the control circuit 230 activates the control signal SDOWN when the ambient temperature is higher than the predetermined temperature.

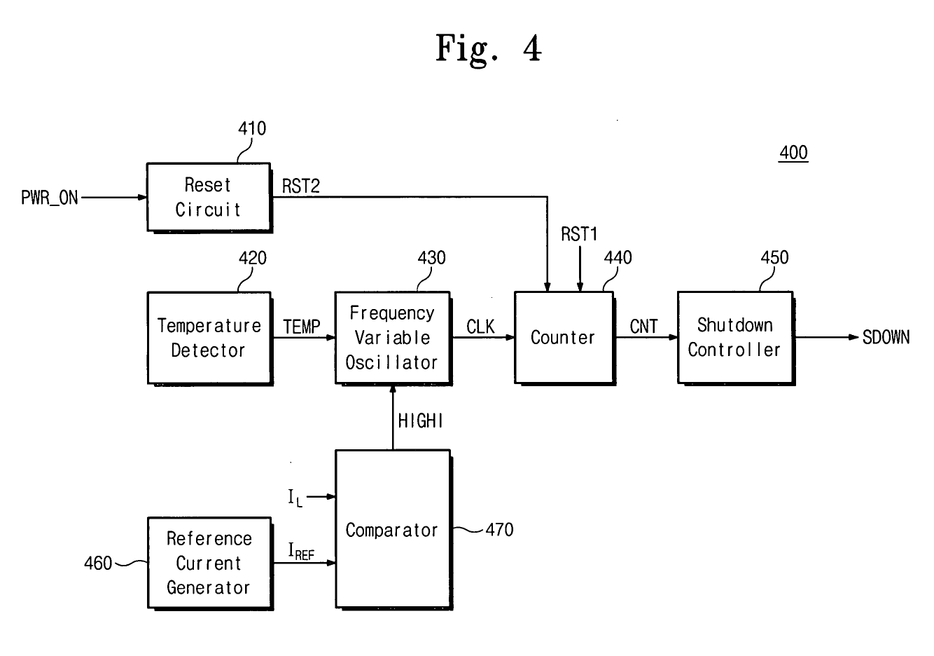

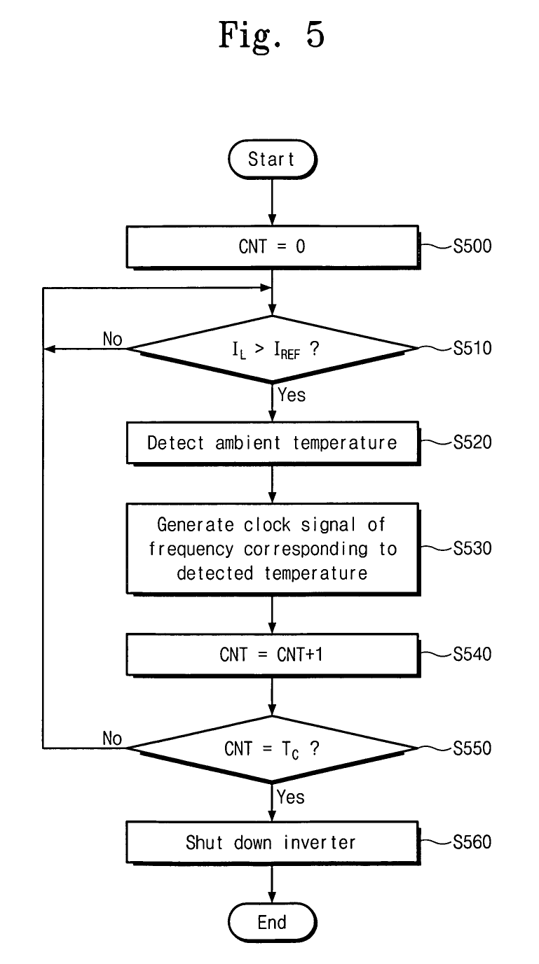

FIG. 4 is a block diagram of the inverter controller 400 according to an embodiment of the present invention, and FIG. 5 is a flowchart illustrating an operation of the inverter controller of FIG. 4. The inverter controller 180 shown in FIG. 1 may be substituted for the inverter controller 400. The inverter controller 400 illustrated in FIG. 4 activates a control signal SDOWN for shutting the inverter 160 when a supply time of the high current from the inverter 160 to the lamp 150 exceeds the allowable time, and also adjusts the allowable time according to a rate of an increase in the ambient temperature.

Referring to FIG. 4, the inverter controller 400 includes a reset circuit 410, a temperature detector 420, a frequency variable oscillator 430, a counter 440, a shutdown controller 450, a reference current generator 460, and a comparator 470.

The reset circuit 410 outputs the reset signal RST2 for resetting the counter 440 when the LCD 100 is reset or powered on (operation S500).

The reference current generator 460 generates the reference current I_{REF} corresponding to the high current supplied from the inverter 160 to the lamp 150 so as to drive the liquid crystal panel 140 in the high brightness state.

The comparator 470 compares the reference current I_{REF} with the current I_{L} supplied from the inverter 160 to the lamp 150. When it is determined that the high current is supplied from the inverter 160 to the lamp 150, the comparator 470 activates a high-current detection signal HIGHI (operation S510).

The temperature detector 420 detects the ambient temperature, and outputs the temperature detection signal TEMP having a level corresponding to the detected temperature (operation S520).

The frequency variable oscillator 430 generates a clock signal CLK of a frequency corresponding to the level of the temperature detection signal TEMP while the high-current detection signal HIGHI is in an active state (operation S530). As the ambient temperature increases, the frequency variable oscillator 430 outputs the clock signal CLK having a higher frequency. When the high-current detection signal HIGHI is in an inactive state, the frequency variable oscillator 430 does not operate.

The counter 440 is reset in response to the reset signal RST1 from the microcontroller 190 of FIG. 1 and the reset signal RST2 from the reset circuit 410 of the inverter controller 400. The counter 440 operates in synchronization with the clock signal CLK outputted from the oscillator 430, and outputs a count value CNT (operation S540).

When the count value CNT from the counter 440 reaches an upper limit value (operation S550), the shutdown controller 450 activates the control signal SDOWN for shutting down the inverter 160 (operation S560). The upper limit value set to the shutdown controller 450 is a value corresponding to a predetermined time T_{c} that is the allowable time for the high current driving. The predetermined time T_{c} is a time set for driving the liquid crystal panel 140 in the high brightness mode. The liquid crystal panel 140 stabilizes to a normal brightness in the power-on mode over time, and a current higher than the normal current is supplied to the lamp 150 so as to reduce the brightness stabilization time. When the predetermined time T_{c} is set considering the brightness stabilization time, it needs to be set within a range in which the lamp 150 is not damaged by overheating.

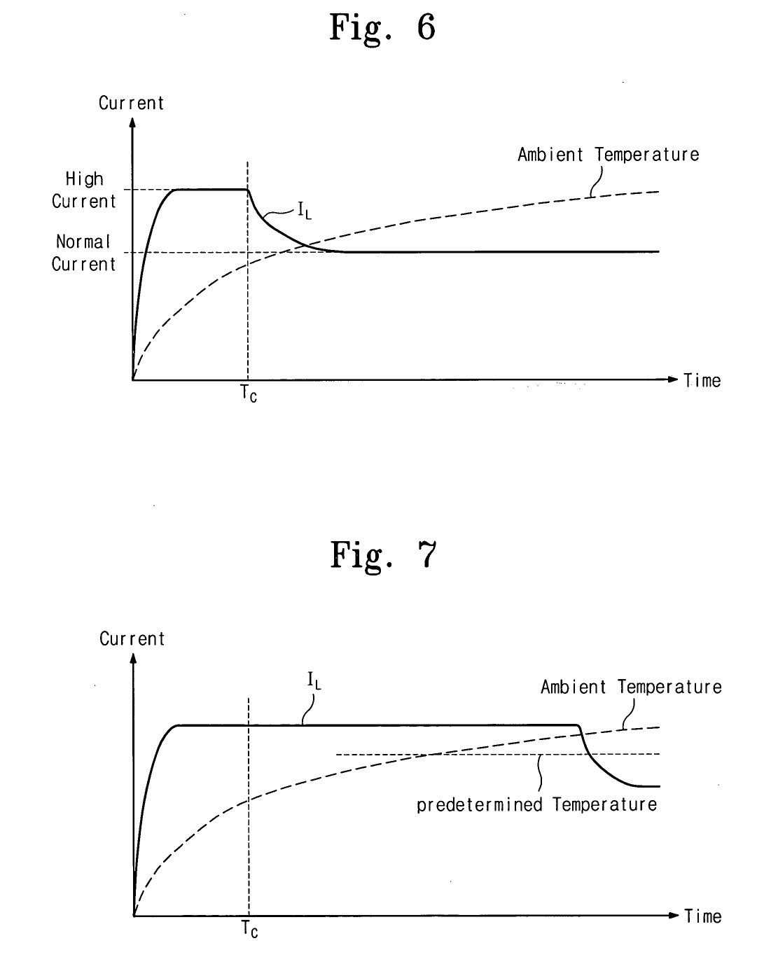

FIG. 6 is a graph illustrating change of a lamp current and the ambient temperature when the LCD is driven in a high brightness mode. In the power-on mode, the inverter 160 supplies a current higher than the normal current to the lamp 150 for the predetermined time T_{c}. After the predetermined time T_{c} elapses, the inverter 160 supplies the normal current to the lamp 150.

FIG. 7 is a graph illustrating change of the lamp current and the ambient temperature, showing that the inverter 160 supplies the lamp with a current higher than the normal current even after the predetermined time T_{c} elapses due to an erroneous operation of the microcontroller 190 illustrated in FIG. 1.

If the supply time of the high current to the lamp 150 becomes long, the ambient temperature may increase up to above the predetermined temperature. If the ambient temperature, that is, the temperature of the lamp, is higher than the predetermined temperature, the lamp 150 may be damaged, e.g., a pinhole may be formed in the lamp 150, etc. When the supply time of the high current from the inverter 160 to the lamp 150 elapses as long as the predetermined time T_{c}, the inverter controller 400 illustrated in FIG. 4 activates the control signal SDOWN to compulsorily shut down the inverter 160, thereby substantially preventing the lamp 150 from increasing up to the predetermined temperature. As the inverter 160 stops operating, the lamp 150 is turned off and thus its temperature is reduced. This control operation can substantially prevent the lamp 150 from being damaged by overheating. In a case where the high-brightness driving stopping operation of the inverter 160 is not correctly controlled due to the erroneous operation of the microcontroller 190, the inverter 160 can be controlled by the inverter controller 400.

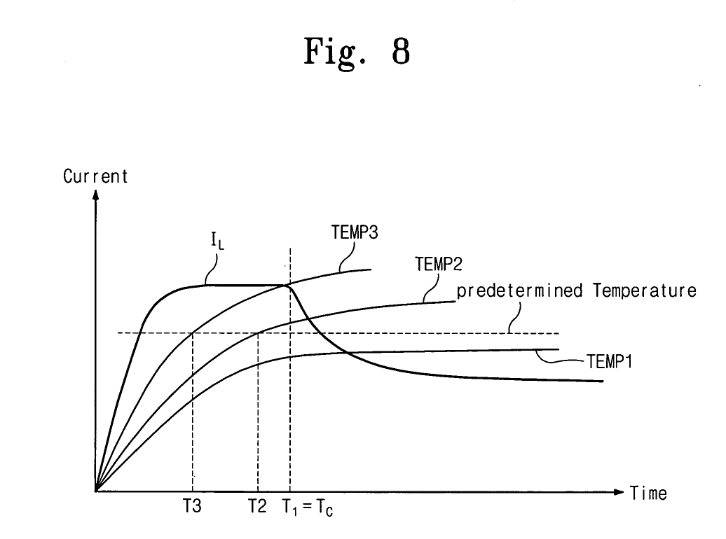

FIG. 8 is a graph exemplarily illustrating an abnormal increase of the ambient temperature. Referring to FIG. 8, a normal increase curve TEMP1 of the ambient temperature according to the change of the current I_{L} supplied from the inverter 160 to the lamp 150 does not exceed the predetermined temperature. When the ambient temperature is high or increases abnormally due to an erroneous operation of the inverter 160, the ambient temperature may increase higher than the predetermined temperature within the predetermined time T_{c}. In this case, if the high current is continuously applied to the lamp 150 for the predetermined time T_{c}, the lamp 150 may be damaged due to overheating.

The damage of the lamp 150 due to the rapid temperature increase can be substantially prevented by controlling the fixed upper limit value of the shutdown controller 450.

The frequency variable oscillator 430 outputs the clock signal CLK of a 5 frequency proportional to the temperature detection signal TEMP outputted from the temperature detector 420. When the ambient temperature increases, the frequency variable oscillator 430 generates the clock signal CLK of a higher frequency. Since the counter 440 operates in synchronization with the clock signal CLK, a time needed for the count value CNT to reach the upper limit value of the shutdown controller 450 is reduced. In FIG. 8, for different rates of the ambient temperature increase TEMP1, TEMP2, and TEMP3, are shown. Also depicted are times corresponding to the rates needed for the count value to reach the upper limit value, respectively shown as T1, T2, and T3. The rates of temperature increase vary from high to low in the order of TEMP3, TEMP2, and TEMP1, and the times needed for the count value to reach the upper limit value varies from low to high in the order of T3, T2, and T1. As the rate of an increase in the ambient temperature becomes greater, the activation time point of the shutdown control signal SDOWN (e.g., the allowable time) is shortened. The allowable time is a time equal to or less than the predetermined time T_{c}

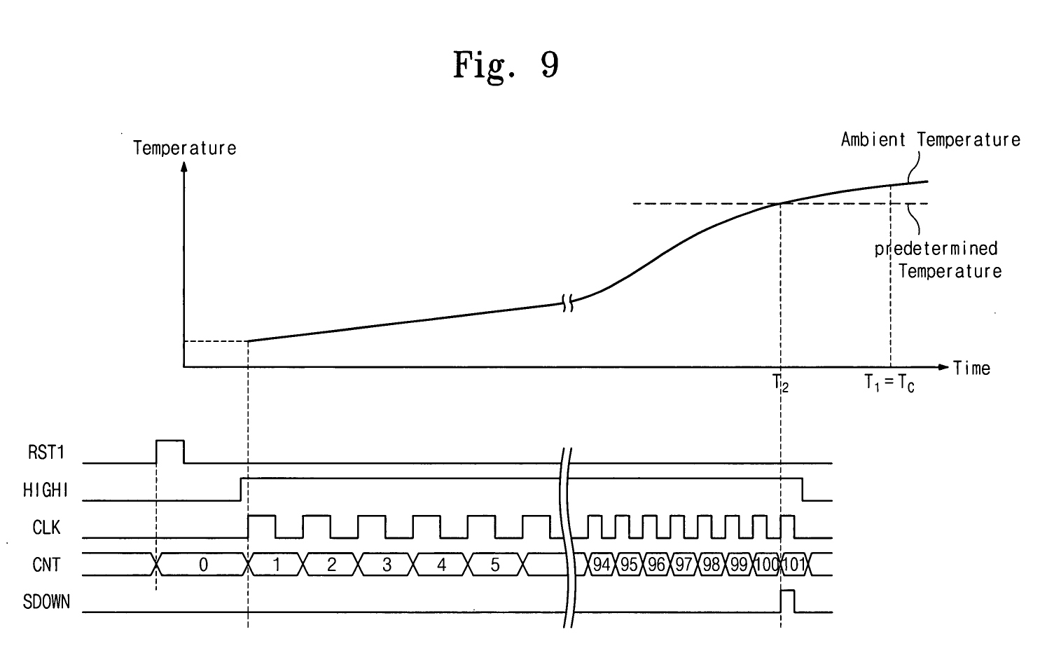

FIG. 9 is a timing diagram of the signals used in the inverter controller of FIG. 4 according to the change of the ambient temperature.

Referring to FIG. 9, the counter 440 is reset in response to the reset signal RST1, and the high-current detection signal HIGHI is activated. In response to the high-current detection signal HIGHI the frequency variable oscillator 430 generates the clock signal CLK of a predetermined frequency corresponding to the temperature detection signal TEMP. The counter 440 outputs the count value CNT in synchronization with the clock signal CLK. When the level of the temperature detection signal TEMP increases, the frequency variable oscillator 430 generates the clock signal CLK of a higher frequency. The shutdown controller 450 activates the shutdown control signal SDOWN when the count value CNT reaches a predetermined value, for example, 100.

The inverter controller 400 shuts down the inverter 160 when the supply time of the high current from the inverter 160 to the lamp 150 exceeds a predetermined time, and reduces the supply time of the high current according to the faster rate increases in the ambient temperature, thereby substantially preventing damage to the lamp 150.

The shutdown controller 450 has a fixed upper limit value and the time needed to reach the upper limit value is controlled. The predetermined time can be controlled by fixing the frequency of the clock signal CLK and reducing the upper limit value as shown in FIGS. 2 and 3.

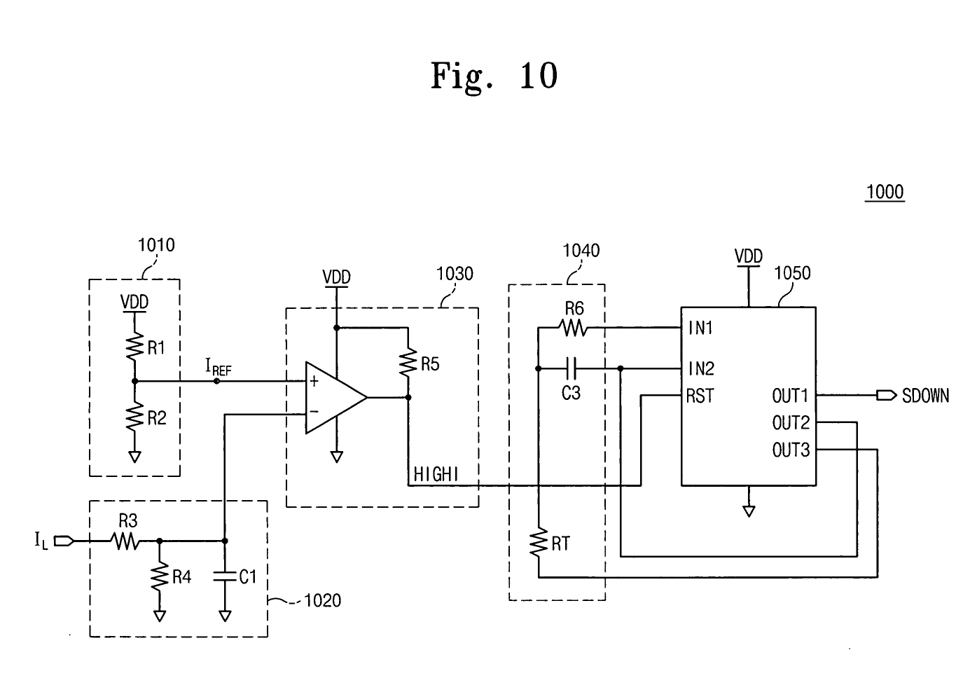

FIG. 10 is a circuit diagram of an inverter controller 1000 according to an embodiment of the present invention. Referring to FIG. 10, the inverter controller 1000 includes a reference current generator 1010, a lamp current input unit 1020, a comparator 1030, and a temperature detector 1040, and an integrated circuit (IC) chip 1050. The inverter controller 180 shown in FIG. 1 may be substituted for the inverter controller 1000.

The reference current generator 1010 outputs a reference current I_{REF} from a connection node disposed between resistors R1 and R2. The lamp current input unit 1020 includes resistors R3 and R4 and a capacitor C1. The comparator 1030 compares the reference current I_{REF} with the lamp current I_{L}. When the lamp current I_{L} is higher than the reference current I_{REF}, the high-current detection signal HIGHI is activated.

The temperature detector 1040 includes a resistor R6, a capacitor C3, and a thermistor RT. The thermistor RT is an element whose resistance varies with temperature.

The IC chip 1050 may be implemented as, for example, HEF4251BP of PHILIPS. The IC chip 1050 includes an oscillator that oscillates according to a resistance determined by the resistor R6 and the thermistor RT and a capacitance of the capacitor C3. The IC chip 1050 outputs a frequency signal corresponding to the resistance of the thermistor RT while the high-current detection signal HIGHI is in an active state, and activates the control signal SDOWN when a predetermined or allowable time elapses.

The inverter controller 1000 illustrated in FIG. 10 shuts down the inverter 160 when the supply time of the high current from the inverter 160 to the lamp 150 exceeds a predetermined or allowable time, and reduces the supply time of the high current according to the increased rate of increase of the ambient temperature, thereby substantially preventing damage to the lamp 150. Accordingly, damage to the lamp caused by the high-brightness driving operation can be reduced.

It will be apparent to those skilled in the art that various modifications and variations can be made in the present invention. Thus, it is intended that the present invention covers the modifications and variations of this invention.

What is claimed is:

1. A liquid crystal display (LCD) comprising:
a lamp;
an inverter for driving the lamp, the inverter supplying a first current to the lamp; and
an inverter controller for shutting down the inverter when a supply time of the first current from the inverter to the lamp exceeds an allowable time, and changing the allowable time according to an ambient temperature while the first current is supplied from the inverter to the lamp.

2. The LCD of claim 1, further comprising a microcontroller for outputting a first- brightness command signal in a power-on mode, wherein the inverter supplies the first current to the lamp in response to the first-brightness command.

3. The LCD of claim 2, wherein the microcontroller outputs the first-brightness command signal in response to an external image data.

4. The LCD of claim 2, wherein the microcontroller generates a reset signal for resetting the inverter controller in the power-on mode.

5. The LCD of claim 1, wherein the inverter controller reduces the allowable time in proportion to a rate of increase of the ambient temperature while the first current is supplied from the inverter to the lamp.

6. The LCD of claim 5, wherein the inverter does not drive the lamp when the shutdown signal is activated by the inverter controller.

7. The LCD of claim 1, wherein the inverter controller includes:
a comparator for activating a first signal when the first current is supplied from the inverter to the lamp;
a temperature detector for outputting a second signal of a level corresponding to the ambient temperature; and
a control circuit for outputting a third signal to shut down the inverter when a time proportional to a rate of change of the second signal elapses while the first signal is activated.

8. The LCD of claim 7, wherein the temperature detector comprises a thermistor.

9. The LCD of claim 7, further comprising a microcontroller for generating a first reset signal to reset the control circuit of the inverter controller in a power-on mode.

10. The LCD of claim 7, wherein the inverter controller further includes a reset circuit for generating a second reset signal to reset the control circuit.

11. The LCD of claim 1, wherein the inverter controller includes:
a comparator for activating a first signal when the first current is supplied from the inverter to the lamp;
a temperature detector for outputting a second signal of a level corresponding to the ambient temperature;
an oscillator for outputting a clock signal of a frequency corresponding to a level of the second signal while the first signal is in an active state;
a counter for outputting a count value in synchronization with the clock signal; and
a controller for outputting a third signal to shut down the inverter when the count value reaches an upper limit value.

12. The LCD of claim 11, wherein the temperature detector comprises a thermistor.

13. The LCD of claim 11, wherein the temperature detector detects a temperature of a region adjacent to the lamp on a circuit board of the inverter controller.

14. The LCD of claim 1, further comprising a power supply for supplying a power supply voltage to the inverter.

15. The LCD of claim 1, wherein the lamp includes a flat fluorescent lamp.

16. A liquid crystal display (LCD) comprising:
a lamp;
an inverter for driving the lamp, the inverter supplying a first current to the lamp; and
an inverter controller for shutting down the inverter when a supply time of the first current from the inverter to the lamp exceeds an allowable time, and shutting down the inverter when an ambient temperature exceeds a predetermined temperature within the allowable time.

17. The LCD of claim 16, further comprising a microcontroller for outputting a first-brightness command signal in a power-on mode, wherein the inverter supplies the first current to the lamp in response to the first-brightness command.

18. The LCD of claim 17, wherein the microcontroller outputs the first-brightness command signal in response to an external image data.

19. The LCD of claim 17, wherein the microcontroller generates a reset signal for resetting the inverter controller in the power-on mode.

20. The LCD of claim 16, further comprising a power supply for supplying a power supply voltage to the inverter.

21. The LCD of claim 16, wherein the lamp includes a flat fluorescent lamp.

22. A controlling method of a liquid crystal display (LCD), comprising:
determining whether an ambient temperature is higher than a predetermined temperature;
determining whether a supply time of a first current from an inverter to a lamp exceeds an allowable time; and
shutting down the inverter when the supply time of the first current exceeds the allowable time, and shutting down the inverter when the ambient temperature exceeds the predetermined temperature within the allowable time.

23. The controlling method of claim 22, further comprising:
determining whether the first current is supplied when the supply time of the high current does not exceeds the allowable time.

24. A controlling method of a liquid crystal display (LCD), comprising:
determining whether a first current is supplied from an inverter to a lamp;
detecting an ambient temperature when the first current is supplied from the inverter to the lamp;
generating a clock signal of a frequency corresponding to a detected ambient temperature;
increasing a count value in synchronization with the clock signal;
determining whether the count value reaches a predetermined count value; and
shutting down the inverter when the count value reaches the predetermined count value.

25. The controlling method of claim 24, further comprising:
determining whether the high current is supplied when the count value does not reach the predetermined count value.

26. The controlling method of claim 25, wherein the operation of shutting down the inverter includes activating a shutdown signal.
